(19) United States
(12) Patent Application Publication
(10) Pub. No.: US 2007/0083919 A1
(43) Pub. Date: Apr. 12, 2007

(54) Secure Image Protocol

(76) Inventor: Guy Heffez, New York, NY (US)

Correspondence Address: WOOD AND EISENBERG, PLLC, 6911 RICHMOND HIGHWAY, SUITE 403, Alexandria, VA, 22306, US

(21) Appl. No.: 11/327,414

(22) Filed: Jan. 9, 2006

Related U.S. Application Data
(60) Provisional application No. 60/724,907, filed on Oct. 11, 2005.

(51) Int. Cl. H04L 9/32

(52) U.S. Cl. 726/5

(57) ABSTRACT

A secure image protocol that can be used as a substitute or additional security layer during the login process or during high-risk transactions. In a first embodiment, the secure image protocol of the present invention is used to provide a secure login. In a second embodiment, the secure image protocol of the present invention is instead used during a login session, and, more particularly, during times when the user requests a high-risk transaction, wherein the secure image protocol provides an extra layer of security during the high-risk transaction.

### CROSS-REFERENCE TO RELATED APPLICATIONS

This application claims the benefit of priority from U.S. Provisional Patent Application Ser. No. 60/724,907, filed Oct. 11, 2005, the entire contents of which is incorporated herein by reference.

### STATEMENT REGARDING FEDERALLY SPONSORED RESEARCH OR DEVELOPMENT

Not Applicable.

### FIELD OF THE INVENTION

This invention relates to a secure image protocol that can be used as a substitute or additional security layer during the login process or during high-risk transactions.

### BACKGROUND OF THE INVENTION

Online financial activity has proved to be a boon for hackers and criminals intent on fooling members of the online community into releasing personal information that can be used later by the criminal to steal or illegally purchase items based on the information illicitly obtained from the unwary online user engaged in, for example, online banking.

### SUMMARY

A secure image protocol that can be used as a substitute or additional security layer during the login process or during high-risk transactions.

In a first embodiment, the secure image protocol of the present invention is used to provide a secure login. For example, a user with an account on an online bank is usually required to provide a password and user name when logging into his online bank. In this example, the secure image protocol provides an extra layer of security to ensure that the user attempting to login is in fact the authorized user.

In a second embodiment, the secure image protocol of the present invention is instead used during a login session, and, more particularly, during times when the user requests a high-risk transaction, wherein the secure image protocol provides an extra layer of security during the high-risk transaction. The term “login session” refers to the period after the user has logged in up to the moment the user logs out or is logged out.

### BRIEF DESCRIPTION OF THE FIGURES

FIG. 1 shows a flow chart according to a first embodiment of the present invention.

FIG. 2 shows a plurality of images according to the present invention.

FIG. 3 shows a plurality of images according to the present invention.

FIG. 4 shows the images of FIG. 3 in random order according to the present invention.

FIG. 5 shows a flow chart according to a second embodiment of the present invention.

### DETAILED DESCRIPTION OF THE INVENTION

This invention is directed to a secure image protocol that can be used as a substitute or additional security layer during the login process or during high-risk transactions.

Examples of websites that would benefit from the present invention include, but are not limited to, Internet banking websites such as those provided by large banks such as Citibank, and smaller financial entities such as DUPAGE Credit Union of Naperville, Ill., USA, which provides twenty-four hour online account access to their bank customers via a website called eCom24.

In a first embodiment, the secure image protocol of the present invention is used to provide a secure login. For example, a user with an account on an online bank is usually required to provide a password and user name when logging into his online bank. In this example, the secure image protocol provides an extra layer of security to ensure that the user attempting to login is in fact the authorized user.

In a second embodiment, the secure image protocol of the present invention is instead used during a login session, and, more particularly, during times when the user requests a high-risk transaction, wherein the secure image protocol provides an extra layer of security during the high-risk transaction. The term “login session” refers to the period after the user has logged in up to the moment the user logs out or is logged out.

In either embodiment, there is no requirement for the user to load software (e.g., from a dedicated compact laser disc (CD)).

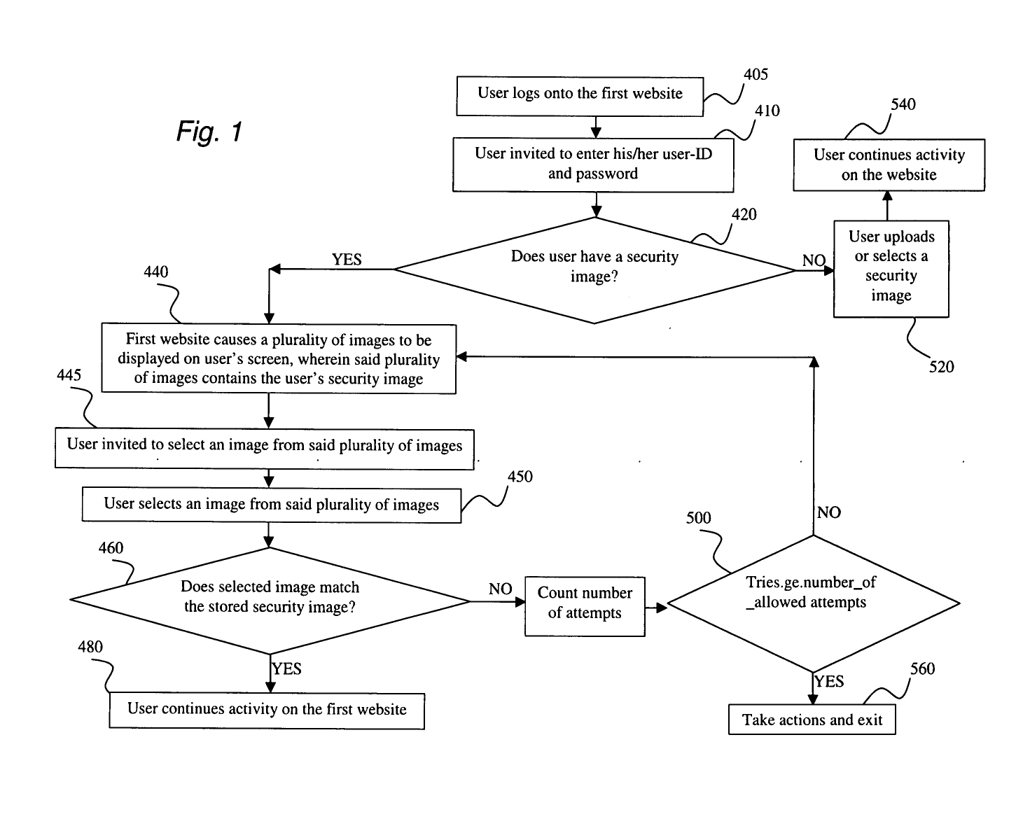

Referring to the first embodiment, FIG. 1 shows a flow chart depicting a non-limiting example of how the invention protects a website (referred to generally as a “first website”). It should be understood that the term “first website” is intended to mean any website that makes use of the functionality of FIG. 1 or its equivalents.

Still referring to FIG. 1, a user, or somebody pretending to be an authorized user, attempts to log onto the first website at 405. The user is invited to enter his/her user-ID and password at 410. If a valid user-ID and password is entered, a check is made at 420 to verify if the user has a security image associated with their account. If not, the user is required to upload or select a security image at 520 and continues activity on the first website at 540. The security image can be any suitable image chosen by the user. For example, the user can elect to upload an image known to the user or select an image from an album of images made available on the first website. Once the user selects an image, this image is treated as a security image associated with the user's account on the first website.

Still referring to FIG. 1, if the user has a security image associated with their account, the first website causes a plurality of images to be displayed on the user's login device at 440, wherein the plurality of images contains the user's security image. The user is invited to select an image corresponding to his/her security image at 445 and selects his/her security image at 450. Once the user selects his/her security image at 450, a check is made at 460 to verify if the user selected image corresponds to the user's actual security image stored on the first website. If the user made an incorrect choice, the user is permitted to retry selecting their security image providing the number of tries does not exceed a predetermined number of allowed tries at 500. Otherwise, suitable actions are taken at 560 such as alerting online support, and/or recording the IP address of the user (or person or entity pretending to be an authorized user), and/or instigating forced exit of the user (or person pretending to be the user) from the first website at 560. Optionally, instead of exiting the user (i.e., forcibly ejecting the user from the first website at 560), a low security score is allocated by the first website service provider such that the user is permitted to carry out activities on the website but is prevented from conducting high-risk transactions such as wire-transfers, adding new payee details, et cetera.

Still referring to FIG. 1, if the user otherwise selects the correct image at 460, the user continues his/her activities on the first web site at 480. The user otherwise ends their web session at 490. More specifically, the first website checks at 460 if the first user's image selection matches the security image of record, and, if there is not a match, the user can either be invited to try again or be ejected from the first website. If the first user's selection matches the security image, then there is a match and the first user is allowed to continue his/her activity at 480. Optionally, if the user correctly selects the right security image at 460 a high security score is associated with the user.

The authorized user has to remember and select the security image at 450 in order to successfully login and enter the first website. Since images are hard to write down yet easy to remember, it is less likely an authorized user would write down or draw the security image. Thus, there is less risk of another person inadvertently or intentionally learning the user's security image.

Alternatively, a user who does not select the correct security image at 460 (in FIG. 1) optionally receives a low security score and is allowed to proceed to step 480, but wherein the user is not permitted to carry out high-risk transactions such as a user requested wire transfer

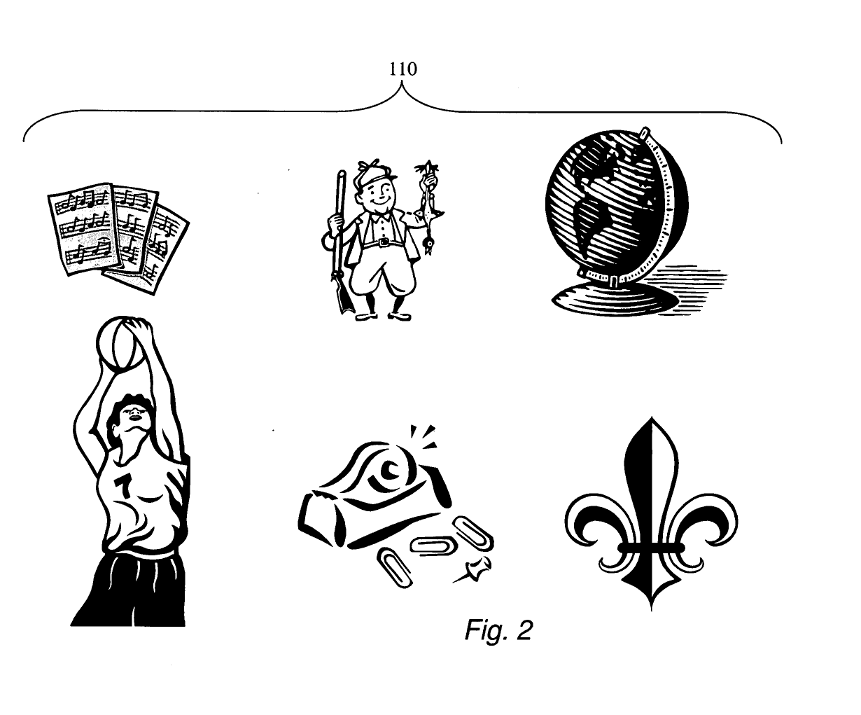

It should be understood that the security image could be any image, such as an image depicting a farm animal, a family member, a wild animal (e.g., a lion), or an image of the user. A plurality of images is shown in FIG. 2, wherein the plurality of images is represented by the numeric label “110”. The first website optionally includes at least one library of images, any one of which the user can select at 520 as his/her preferred security image. Otherwise, the user can upload an image at 520 for use as the user's security image.

If a user elects to upload an image for use as his/her security image, the image is typically uploaded from the user's computer hard drive and hence has an associated file name (with respect to the hard drive). The file name of an uploaded image is stored by the website and optionally changed by the website to provide additional security.

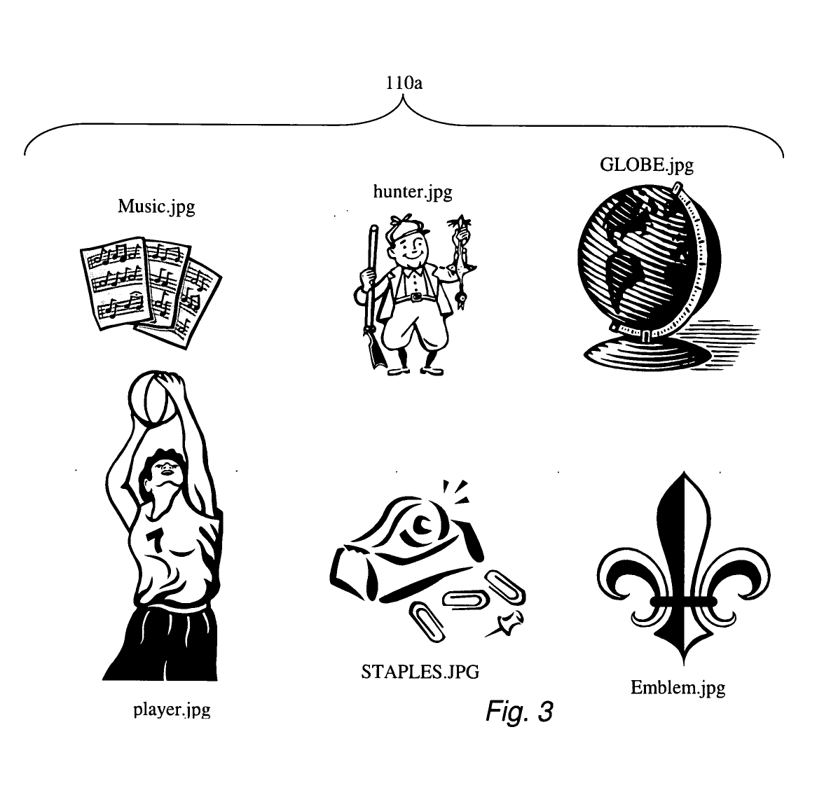

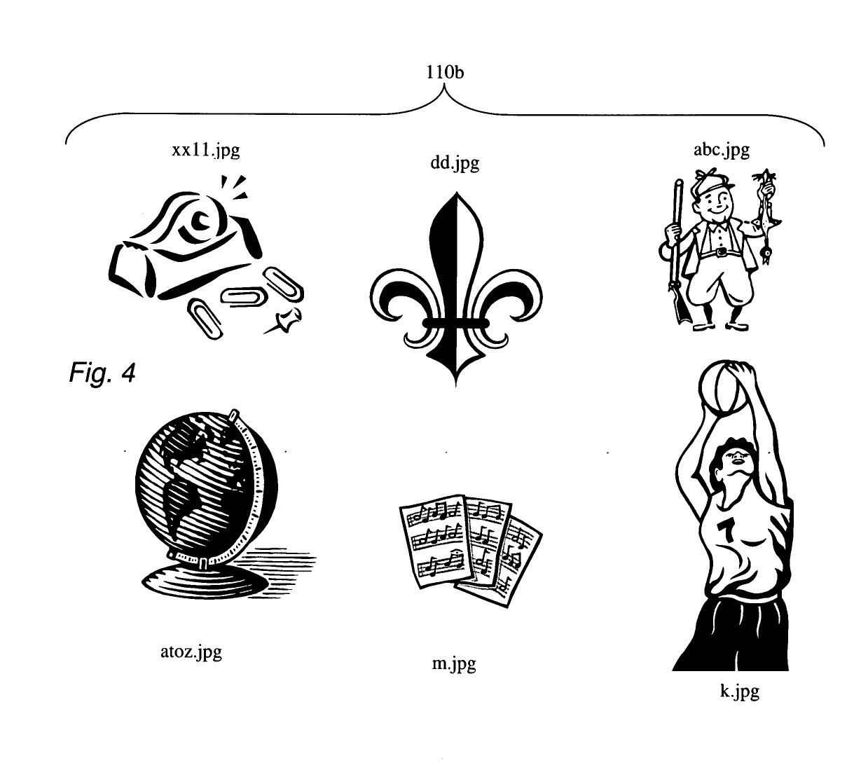

In addition, file names associated with displayed images, including security images associated with users, may be changed randomly to provide a further level of protection. For example, file names can be displayed along with the plurality of images (represented by alphanumeric label “110a” in FIG. 3). The file names can be substituted for different file names or mixed up (see FIG. 4, where different file names are associated with the images, represented by alphanumeric label “110b”). The plurality of images can also be displayed in a random order compared to previous login attempts, e.g., compare 110a and 110b. A user can be invited to select their security image from a plurality of images 110b even when the file name has changed. Such file name changes are to make it harder for hackers to hack personal ID details of users. The plurality of images 110, 110a, or 110b can be displayed on the user's remote display device (such as the user's home computer, a PDA, or wireless cell phone), from which the user is required to select his/her correct security image.

It should be understood that the images displayed on the user's remote device could be displayed in any order, and the number of images displayed could vary. The only requirement is that the images relayed to the user's remote device include the user's security image.

Thus, should a hacker intercept an uploaded image in transit and learn the file name of the uploaded image, the name of the uploaded image is of no use should the hacker later try to hack into the user's account based on the file name of the image uploaded by the user. This extra layer of security makes it harder for hackers to infiltrate a user's website account.

In a version of the first embodiment, a method comprises the steps of: verifying if a user has authority to login into the website, wherein the user is required to enter their user ID and password; displaying a plurality of images, wherein the plurality of images includes the security image associated with the user, and wherein the plurality of images includes images selected at random from a library of images; and requiring the user to correctly select the security image associated with the user prior to allowing the user to enter the website.

In another version of the first embodiment, a method comprises the steps of: verifying if a user has authority to login into the website, wherein the user is required to enter their user ID and password; displaying a plurality of images, wherein the plurality of images includes the security image associated with the user, and wherein each time the user attempts to login into the website, the plurality of images is displayed in a random order; and requiring the user to correctly select the security image associated with the user prior to allowing the user to enter the website.

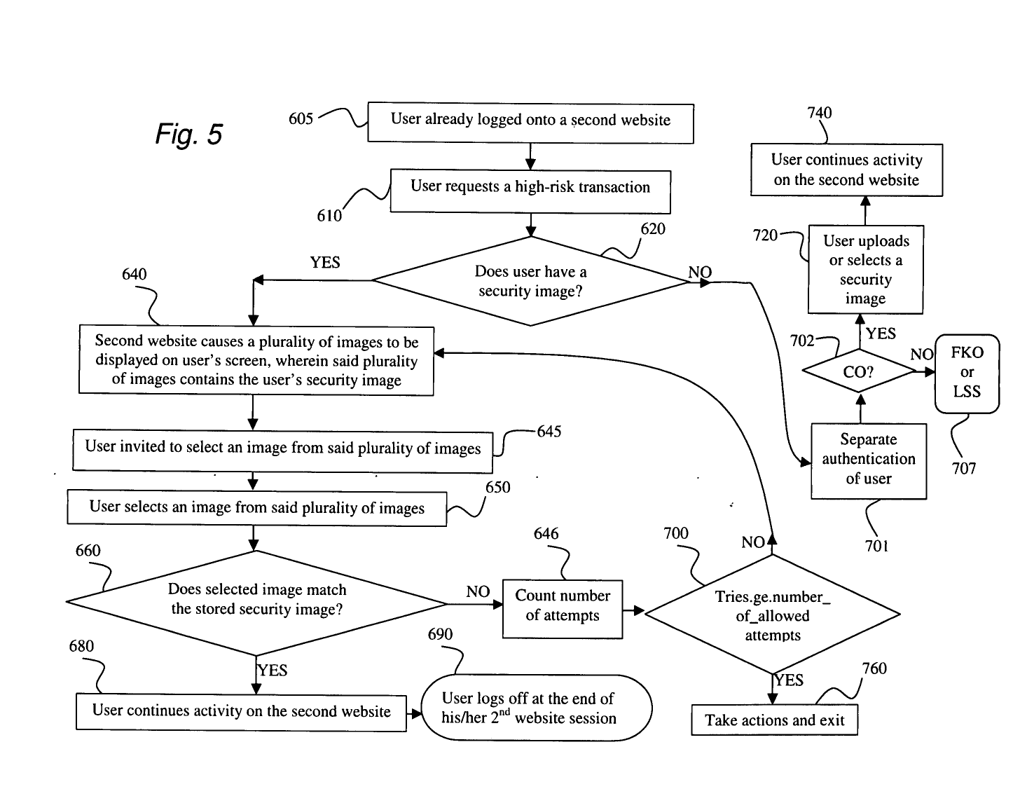

Referring to the second embodiment, FIG. 5 shows a flow chart depicting a non-limiting example of how the invention protects a website (referred to as a “second website”). It should be understood that the term “second website” is intended to mean any website that makes use of the functionality of FIG. 5 or its equivalents.

Still referring to FIG. 5, a user, or somebody pretending to be an authorized user, is already logged onto the second website at 605. The user, or somebody pretending to be an authorized user, requests a high-risk transaction at 610. A check is made at 620 to verify if the user has a security image associated with their account. If not, the user is required to go through a security authentication at 701. If the security authentication checks out at 702, the user proceeds to upload or select a security image at 720 and then proceeds with web activity at 740, otherwise the user is forcibly kicked out or given a low security score at 707 (a low security score prevents the user from engaging in high risk transactions on the second website). The security image can be any suitable image chosen by the user. For example, the user can elect to upload an image known to the user or select an image from an album of images made available on the second website. Once the user selects an image, this image is treated as a security image associated with the user's account on the second website.

Still referring to FIG. 5, if the user has a security image associated with their account at 620, the second website causes a plurality of images to be displayed on the user's login device at 640, wherein the plurality of images contains the user's security image. The user is invited to select an image corresponding to his/her security image at 645 and selects his/her security image at 650. Once the user selects his/her security image at 650, a check is made at 660 to verify if the user selected image corresponds to the user's actual security image stored on the first website. If the user made an incorrect choice, the user is permitted to retry selecting their security image providing the number of tries counted at 646 does not exceed a predetermined number of allowed tries at 700. Otherwise, suitable actions are taken at 760 such as alerting online support, and/or recording the IP address of the user (or person or entity pretending to be an authorized user), and/or instigating forced exit of the user (or person pretending to be the user) from the second website, and/or given a low security score to prevent the user from engaging in high risk transactions on the second web site.

Still referring to FIG. 5, if the user otherwise selects the correct image at 660, the user continues his/her activities on the second web site at 680. More specifically, the second website checks at 660 if the first user's image selection matches the security image of record, and, if there is not a match, the user can either be invited to try again at 700 (providing the number of attempts is not greater than a predetermined number of allowed attempts), be ejected from the second website at 760 or subjected to a low security score wherein the user is restricted to low risk, i.e., the user is not permitted to engage in high risk transactions such as setting up a wire transfer. If the first user's selection matches the security image, then there is a match and the first user is allowed to continue his/her activity at 680. The user otherwise ends their web session at 690.

Referring to the first and second embodiments (exemplified in FIGS. 1 and 5), since images are hard to write down yet easy to remember, it is less likely an authorized user would write down or draw the security image. Thus, there is less risk of another person inadvertently or intentionally learning the user's security image.

It is to be understood that the present invention is not limited to the embodiments described above or as shown in the attached figures, but encompasses any and all embodiments within the spirit of the invention.

I claim:

1. A method for providing a secure login to a website, wherein a user's authority to enter the website is checked for authenticity, the method comprising the steps of:
verifying that a user has authority to login into the website, wherein the user is required to enter their user ID and password;
displaying a plurality of images, wherein the plurality of images includes the security image associated with the user; and
requiring the user to correctly select the security image associated with the user prior to allowing the user to enter the website.

2. The method for providing a secure login according to claim 1, wherein each of the plurality of images comprises a file name, wherein the file names change whenever the plurality of images are displayed.

3. The method for providing a secure login according to claim 1, wherein the plurality of images includes images selected at random from a library of images.

4. The method for providing a secure login according to claim 1, wherein the step of requiring the user to correctly select the security image further comprises the step of counting the number of times the user attempts to correctly select the security image, wherein if the number of attempts exceeds a predetermined number of allowed attempts, then the user is forced to exit without entering the website.

5. The method for providing a secure login according to claim 1, wherein the step of requiring the user to correctly select the security image further comprises the step of counting the number of times the user attempts to correctly select the security image, wherein if the number of attempts exceeds a predetermined number of allowed attempts, then the user is allocated a low security score.

6. The method for providing a secure login according to claim 1, wherein the step of requiring the user to correctly select the security image further comprises the step of counting the number of times the user attempts to correctly select the security image.

7. A method for providing a secure login to a website, wherein a user's authority to enter the website is checked for authenticity, the method comprising the steps of:
verifying if a user has authority to login into the website, wherein the user is required to enter their user ID and password;
displaying a plurality of images, wherein the plurality of images includes the security image associated with the user, and wherein each time the user attempts to login into the website, the plurality of images is displayed in a random order; and
requiring the user to correctly select the security image associated with the user prior to allowing the user to enter the website.

8. The method for providing a secure login according to claim 7, wherein each of the plurality of images comprises a file name, wherein the file names change whenever the plurality of images are displayed.

9. The method for providing a secure login according to claim 7, wherein the plurality of images includes images selected at random from a library of images.

10. The method for providing a secure login according to claim 7, wherein the step of requiring the user to correctly select the security image further comprises the step of counting the number of times the user attempts to correctly select the security image, wherein if the number of attempts exceeds a predetermined number of allowed attempts, then the user is forced to exit without entering the website.

11. The method for providing a secure login according to claim 7, wherein the step of requiring the user to correctly select the security image further comprises the step of counting the number of times the user attempts to correctly select the security image, wherein if the number of attempts exceeds a predetermined number of allowed attempts, then the user is allocated a low security score.

12. The method for providing a secure login according to claim 7, wherein the step of requiring the user to correctly select the security image further comprises the step of counting the number of times the user attempts to correctly select the security image.

13. A method for providing a secure login, wherein a user's authority to enter is checked for authenticity, the method comprising the steps of:
verifying if a user has authority to login wherein the user is required to enter their user ID and password;
displaying a plurality of images if the user has authority to login into the website, wherein the plurality of images includes the security image associated with the user; and
requiring the user to correctly select the security image associated with the user, wherein each time the user attempts to login, the plurality of images is displayed in a random order, whereby the user is required to select the correct security image from the plurality of images to enter.

14. The method for providing a secure login according to claim 13, wherein the step of requiring the user to correctly select the security image further comprises the step of counting the number of times the user attempts to correctly select the security image.

15. A method for providing an extra layer of security wherein a user, already logged onto a second website, requests a high-risk transaction, the method comprising the steps of:
detecting when a user requests a high-risk transaction;
verifying if the user has a security image associated with the second website;
displaying a plurality of images if the user has a security image associated with the second website, wherein the plurality of images includes the security image associated with the user; and
requiring the user to correctly select the security image associated with the user prior to allowing the user to perform the high-risk transaction.

16. The method according to claim 15, wherein each of the plurality of images comprises a file name, wherein the file names change whenever the plurality of images are displayed.

17. The method according to claim 15, wherein the plurality of images includes images selected at random from a library of images.

18. The method according to claim 15, wherein the step of requiring the user to correctly select the security image further comprises the step of counting the number of times the user attempts to correctly select the security image, wherein if the number of attempts exceeds a predetermined number of allowed attempts, then the user is forced to exit without entering the website.

19. The method according to claim 15, wherein the step of requiring the user to correctly select the security image further comprises the step of counting the number of times the user attempts to correctly select the security image, wherein if the number of attempts exceeds a predetermined number of allowed attempts, then the user is allocated a low security score.

20. The method according to claim 15, wherein the step of requiring the user to correctly select the security image further comprises the step of counting the number of times the user attempts to correctly select the security image.
